(19) United States
(12) Patent Application Publication
(10) Pub. No.: US 2011/0035375 A1
(43) Pub. Date: Feb. 10, 2011

(54) BUILDING USER PROFILES FOR WEBSITE PERSONALIZATION

(76) Inventor: Ron Bekkerman, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/536,498

(22) Filed: Aug. 6, 2009

(51) Int. Cl. G06F 17/30

(52) U.S. Cl. 707/734; 707/E17.108

(57) ABSTRACT

One embodiment is a method that builds a website profile from keywords appearing at the website and builds a user profile from a subset of the keywords that appear in documents accessed by the user. A web page is personalized based on the user profile.

### BACKGROUND

User profiles are a collection of personal information that is associated with a particular user. These profiles represent an identity or interest of a person and are expressed in terms of categories in which a user has previously shown an interest.

The information contained in a user profile is useful for many applications and systems that take into account characteristics and preferences of the user. For example, user profiles can be used to provide target marketing over the internet or email, display specific advertisements at websites, and tailor search results from a search engine.

### BRIEF DESCRIPTION OF THE DRAWINGS

FIG. 1 is a computer network in accordance with an example embodiment of the present invention.

FIG. 2 is a method for building a profile of a website in accordance with an example embodiment of the present invention.

FIG. 3 is a method for building a profile of user in accordance with an example embodiment of the present invention.

FIG. 4 is a method for personalizing a website according to a user profile in accordance with an example embodiment of the present invention.

FIG. 5 is a computer system for implementing processes in accordance with an example embodiment of the present invention.

### DETAILED DESCRIPTION

Example embodiments relate to apparatus, systems, and methods that build a user profile and personalize a website based on the user profile.

Example embodiments construct a profile of a website (website profile) and derive a profile of a user (user profile) from a re-weighted portion of the website profile. The website profile is represented as a list of key phrases or keywords that are extracted from the website. As discussed in more detail below, these key phrases are weighted according to their “importance” to the website and stored as a list. If this list of key phrases is too short, it is enlarged using a web search engine. The user profile is constructed as a subset of the key phrases of the website. This subset of key phrases appear in documents that the user has accessed and are re-weighted given a potential interest of the user in corresponding content items. The documents do not necessarily include the website (i.e., the user profile can be built even though the user did not previously visit the website from which the keywords are extracted). Once constructed, such a user profile can be employed for website personalization in various forms.

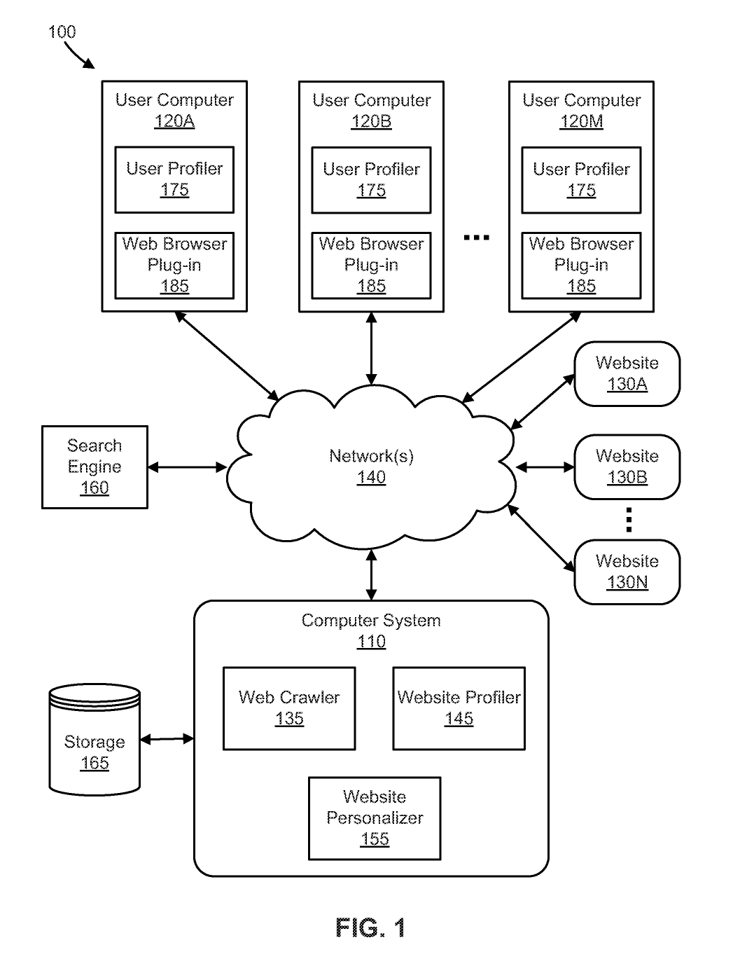

FIG. 1 is a computer network or system 100 in which example embodiments are practiced. The system 100 includes a computer system 110 in communication with a plurality of user electronic devices or computers (shown as user computer 120A, 120B, to 120M) and websites (shown as website 130A, 130B, to 130N) through one or more networks 140. The computer system 110 further includes or is in communication with a web crawler 135, a website profiler 145, a website personalizer 155, and storage 165 (such as a database). Each user computer 120A-120M includes a user profiler 175 and a web browser plug-in 185. Further, a search engine 160 is in communication with the computer system 110 through network 140.

Example embodiments are not limited to any particular type of user computer 120A-120M since various portable and non-portable computers and/or electronic devices may be utilized. Example user computers include, but are not limited to, computers (portable and non-portable), laptops, notebooks, servers, workstations, personal digital assistants (PDAs), tablet PCs, handheld and palm top electronic devices, compact disc players, portable digital video disk players, radios, cellular communication devices (such as cellular telephones), televisions, and other electronic devices and systems whether such devices and systems are portable or non-portable.

The network 140 is not limited to any particular type of network or networks. The network 140, for example, can include one or more of a local area network (LAN), a wide area network (WAN), the Internet, an extranet, or an intranet, to name a few examples.

The computer system 110 is not limited to any particular type of computer or computer system. The computer system 110 can include personal computers, mainframe computers, servers (such as web servers, application servers, database servers, etc.), databases, and gateway computers, to name a few examples.

For convenience of illustration, an exemplary embodiment is illustrated in conjunction with a search engine 160 and a web crawler 135. Exemplary, as used herein, denotes an example. This illustration, however, is not meant to limit embodiments with search engines and web crawlers. Further, exemplary embodiments do not require a specific search engine or web crawler. The search engine and web crawler can be any kind of search engine or web crawler now known or later developed. For example, exemplary embodiments are used in conjunction with existing search engines, such as GOOGLE™ or BING™.

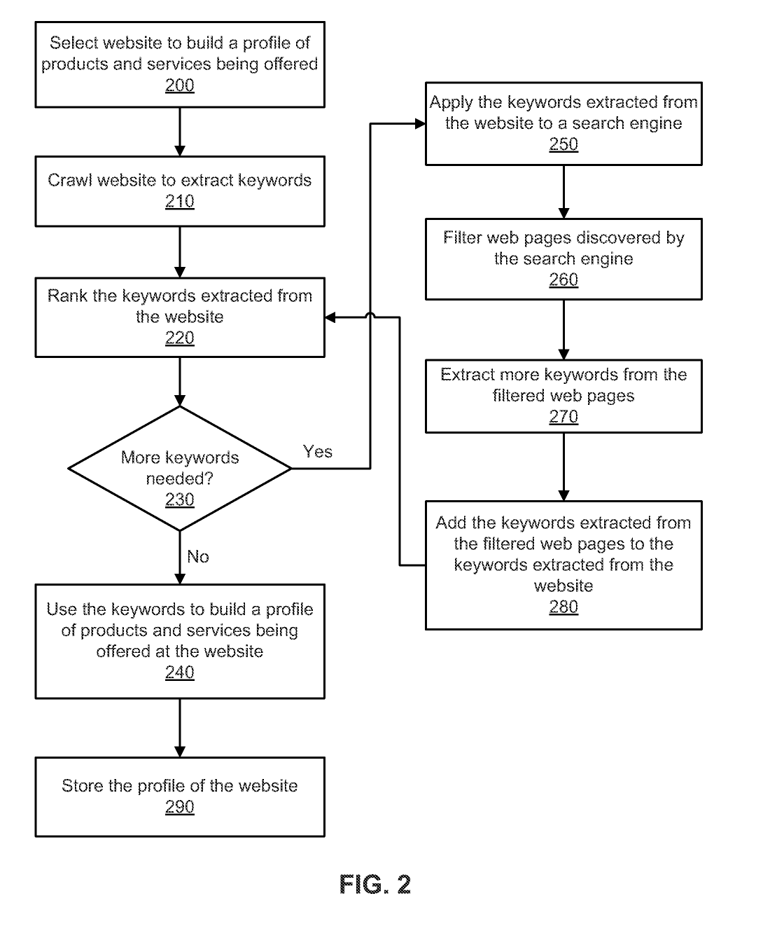

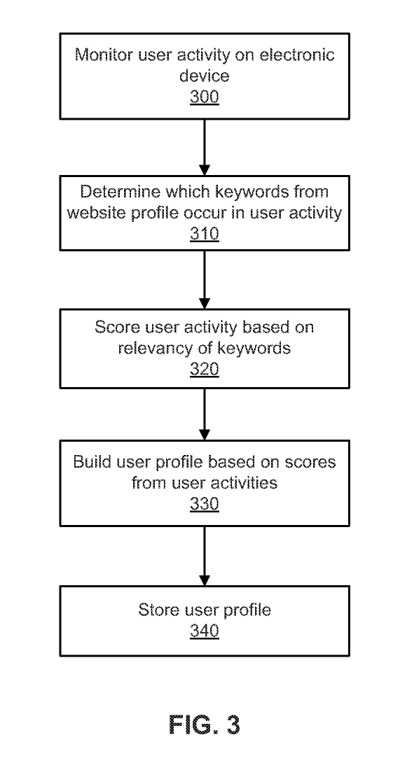

FIGS. 2 and 3 are discussed on connection with FIG. 1.

FIG. 2 is a method for building a profile of a website in accordance with an example embodiment. For example, a model or profile is built of services offered by a company through a website of the company.

As used herein and in the claims, the terms “building a profile” or “building a model” refer to the construction of the profile or model by extracting information from a set of data, such as data from a document.

The website profile is constructed to represent the scope of a particular website's content. In one embodiment, the website profile is a list of items that the website would like to know whether or not a user is interested in those items. Each item is described with one or more key phrases. For example, a website profile for company that sells person computers and printers would contain key words or key phrases such as “notebooks”, “printers”, “printer paper”, together with particular model names of the company's products, their parts (“rechargeable battery”), their properties (“wireless optical”), etc. One example embodiment builds the website profile from key phrases that are either one-word long (“unigrams”) or two-words long (“bigrams”). Example embodiments, however, are not limited to one or two word phrases and include keywords and phrases that have many words.

As used herein and in the claims, the terms “keyword” or “key phrase” define a controlled vocabulary where a word is associated with this vocabulary based upon some type of predefined statistical probability of the word occurring in a document.

According to block 200, a website is selected to build a profile of products and services being offered at or through the website. For example, one of the websites 130A-130N is selected. These websites are accessible over the networks.

In one embodiment, a website profile K_{w} is automatically constructed from content of the website.

According to block 210, the website is crawled to extract keywords. For example, one of the websites 130A-130N (such as website 130A) is crawled with web crawler 135 in computer system 110 and keywords are extracted from the website. Information about products and/or services offered at the website is obtained.

In one embodiment, the entire contents of the website w are obtained either by crawling it or by creating a dump of its database. In one embodiment, crawling is downloading the contents of an original webpage as well as other webpages hyperlinked from the original webpage.

According to block 220, the keywords extracted from the website 130A are ranked. For example, keywords occurring more often at the website are given a higher rank or weight.

In one embodiment, the contents of w are scanned, and a list of key phrases is created. All pages of w are cleaned of any markup and stopwords (i.e. the most common words in the language, such as “the”, “it”, etc.) are removed. The remaining content is split into unigrams (single words) and to bigrams (consequent word pairs). The unigrams and bigrams are organized into a key phrase or keyword list.

For each key phrase k, the list is updated by incrementing k's count cₖ (the number of k's occurrences in w). The list of key phrases is sorted by the probability of a key phrase k to “lead” to the website w (i.e. the chance that a random appearance of k will occur on w) as follows:

P(w|k)=(P(k|w)·P(w))/P(k)∝(cₖ/cₖ)=S_{w}(k).

Here, Cₖ is an estimated number of k's occurrences in the entire Web. S_{w}(k) is the website score of k.

This procedure allows constructing a list of key phrases mentioned in a particular website, ordered by their level of “importance” to the website. Consider for example an online retailer that sells personal computers and printers, a specific model name of a top selling notebook computer would be one of the most important key phrases for the website. The specific model name would occur frequently at the website, but not often in entire Web. This means that if a Web user is interested in the specific model name, the company's website would be most interested to know the user's interest in this product. On other hand, the least important key phrase for company's website might be “book.” While this word does appear on the company's website, the word appears less often than it does in the rest of the Web. Note that if a website has a lot of dynamic content, then its profile K_{w} is periodically regenerated.

According to block 230, a determination is made as to whether more keywords are needed (i.e., did the website 130A include a sufficient number of keywords that were extracted). If the answer to this determination is “yes” then flow proceeds to block 240. If the answer to this determination is “no” then flow proceeds to block 250 and steps are initiated to enrich a number or amount of keywords.

The determination as to whether more keywords are needed can vary depending on factors such as, but not limited to, computational expense associated with processing, a number of hits from users, a frequency of hits from users, the breadth or extensiveness of the subject matter from which the keywords are derived, etc. For example, in one example embodiment, hundreds or thousands or keywords are sufficient. In other embodiments, many more keywords are used. To determine a sufficient number of keywords, one example embodiment deploys the system or method in accordance with the invention and determines whether and how frequently users hit the keywords. If the frequency is deemed insufficient, for example by a system administrator, then the number of keywords profiled from the website is enlarged.

According to block 250, the keywords extracted from the website 130A are applied as search terms or query to a search engine. For example, the keywords are applied to search engine 160 which discovers more websites or web pages per the keywords. For each such query, n web pages are retrieved that are the most highly ranked searched results.

According to block 260, the web pages discovered by the search engine are filtered. For example, web pages not relevant to the products and/or services of the initial website 120A are disregarded. In one embodiment, a one-class clustering mechanism is applied to filter the search results that appear to be noise with respect to the bulk of the other search results.

According to block 270, keywords are extracted from the filtered web pages.

According to block 280, the keywords extracted from the filtered web pages are added to the keywords extracted from the website 130A. The keywords extracted from the web pages are used to augment or add to a list of keywords initially extracted from the website 130A. Counts of the added keywords are weighted with the website scores of their corresponding queries. For example, given a query, a search engine builds a list of documents ranked in a hierarchical list ordered by their relevance to the query. These documents are downloaded, and the keywords are extracted from the documents. The keywords extracted from the top of the list are generally more relevant than the keywords extracted from documents in the bottom of the list. One example embodiment weights the keyword counts with the positions of the document from which they were extracted. Other forms of re-weighing can also be used, such as re-weighing techniques that take into account the document relevance to the query.

Flow proceeds back to block 220, where the list of keywords (i.e., keywords from the website 130A and web pages) is ranked. If no more keywords are needed, flow proceeds to block 240 where the ranked keywords are used to build a model or profile of the products and services being offered at the website 130A. For example, website profiler 145 of computer system 110 builds a profile for the website 130A.

According to block 290, the profile of the website is stored. For example, the profile is stored in storage 165, displayed on a display of a computer, transmitted through network 140, etc.

FIG. 3 is a method for building a profile of user (i.e., user profile) in accordance with an example embodiment.

As used herein and in the claims, the term “user profile” is a collection of personal information that is associated with a particular user. A user profile represents an identity or interest of a person and is expressed in terms of categories in which a user has previously shown an interest.

According to block 300, user activity on an electronic device or computer is monitored. For example, user activity on one or more of the user computers 120A-120M (such as 120A) is monitored. User activity includes, but is not limited to, reading, displaying, storing, transmitting, and navigating to emails, documents, websites or web pages, etc.

As used herein and in the claims, the term “document” is a writing that provides information or acts as a record of events or arrangements. By way of example, “documents” include, but are not limited to, electronic files (data files, text files, program files, etc.), stored information (such as information stored in a database or memory), text, computer files created with an application program, websites, images, emails, publications, and other writings.

In one example embodiment, the web browser plug-in 185 monitors activity on the user computer 120A and records information, such as which web pages a user visits. These web pages visited by the user are scanned for keywords. As another example, emails or documents that a user reads or that are displayed or stored on the user computer are scanned for keywords.

In one example embodiment, documents displayed or stored on a user's computer are scanned. These documents (such as web pages visited by the user) can include or not include the web pages used to build the web page profile discussed in connection with FIG. 2.

In one embodiment, the web browser plug-in is installed on the user computer and continuously collects relevant information, in particular the HTML (hypertext markup language) content of all pages visited by a user. Depending on the computational resources that are available for the application, the browsing history of the user can then be analyzed using a technique of appropriate complexity. A transformation of visited pages into a Bag-of-Bigrams (pairs of consecutive words) or BOW (bags of words) representation is computationally quick and can be operationalized as a service (process) that is constantly running in the background. This background process transforms and stores each web page at the same time the web browser displays it to the user.

According to block 310, a determination is made as to which keywords from the website profile occur in the user activity.

According to block 320, user activity is scored based on a relevancy of the keywords. A determination is made as to how relevant or interesting a user activity on the user computer or activity associated therewith is with respect to products and/or services offered at the website. For example, if user visited a single website with a few keywords several years ago, then this website would not be particularly relevant; and this website or terms extracted from the website are weighted to zero.

According to block 330, a user profile is built based on scores from the user activities. For example, user profiler 175 in user computer 120A builds the user profile.

Given a website profile K_{w}, a user profile Kᵤ consists of those key phrases from K_{w}, which were accessed by the user. For example, the user profile is constructed from a stream of documents the user accesses while using a personal computer (or other electronic devices). These documents can be web pages, as well as email messages, presentations, spreadsheets, etc. (filtered depending on the user's preferences). Each document d is scanned for key phrases from K_{w}. For each key phrase k, its user score sᵤ(k) is maintained: if k is found in d, its score sᵤ(k) is incremented by 1. Periodically, this score gets decremented by a fraction, in order to preserve the time consistency of Kᵤ (i.e. if a key phrase has not been seen for a long time, this would indicate that the user is less interested in the corresponding content item). The user profile score, Sᵤ(k), can be calculated in a similar manner to the calculation provided for the website score.

Thus in one embodiment, user profile Kᵤ consists of key phrases k sorted by sᵤ(k)s_{w}(k). In other words, at each moment of time, the user profile Kᵤ contains an updated list of key phrases that are of the mutual interest of the user u and the website w, in the order that reflects the level of their interest. Such a list can be then used for personalizing content of the website.

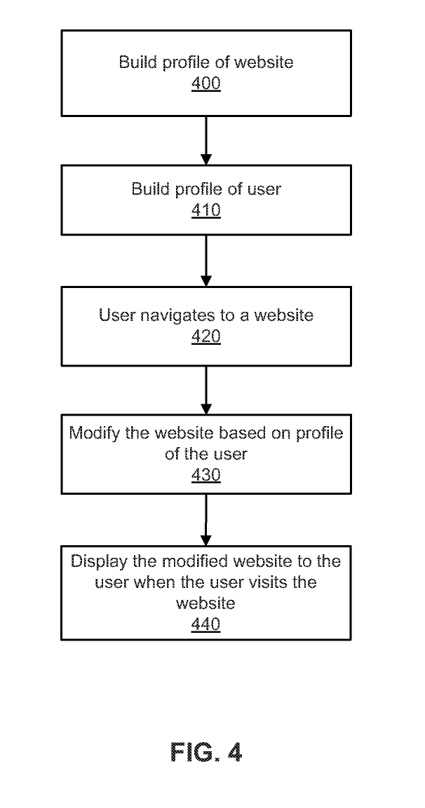

According to block 340, the user profile is stored. For example, the user profile is stored in memory of the user computer 120A or sent through network 140 and stored on a cloud, server, or computer system, such as stored in computer system 110. Alternatively, the user profile is used to change or alter content of a website before a user navigates to the website (see flow diagram of FIG. 4).

In one example embodiment, the user can control where, when, and/or how the user profile is built. For example, the user computer of the user can build the profile and transmit (upon receiving permission from the user) the profile to a cloud or external computer or server. Alternatively, the user profile can be automatically built based on monitoring traffic to and from the user computer. For example, a monitoring service executes on a router or web server and builds a user profile (as opposed to having the user profile built at the user's computer).

FIG. 4 is a method for personalizing a website according to a user profile in accordance with an example embodiment of the present invention.

According to block 400, a profile of a website is built. For example, the website profile is built using the method discussed in connection with FIG. 1.

According to block 410, a profile of a user is built. For example, the user profile is built using the method discussed in connection with FIG. 2.

According to block 420, the user navigates to a website.

According to block 430, the website is modified based on the profile of the user. For example, the website personalizer 155 shown in FIG. 1 modifies the website. The website is personalized or customized based on previous user activities or user interests so when the user navigates or visits the website, the user is shown products, services, and/or advertisements related to, associated with, or customized with the previous user activities. For example, a website is automatically modified or changed according to a profile of a user when the user navigates to the website.

According to block 440, the modified website is displayed to the user when the user visits the website.

In one embodiment, a number of most highly ranked key phrases from Kᵤ is used as queries to the website's search module, which will generate a ranked list of documents retrieved on those queries. Such a ranked list is organized into a body of content the user sees as the user accesses the website.

A user profile can reflect the user's interest in more than one website. The technique proposed above can be generalized to this case, by separately maintaining the user score sᵤ(k) and the website score s_{w}(k) for each website. As soon as the website-specific user profile is needed, the scores are multiplied and the key phrases are sorted by request.

Modified or custom websites are personalized according to the interests of each particular user. A single website is customized differently for each individual user with a user profile. A personalized website provides an improved marketing environment that results in higher click-through rates, greater user satisfaction, and larger revenues through increased sales.

The profiling mechanisms in accordance with example embodiments are generic enough to be used for personalizing any type of websites, regardless of the content they offer and a level of depth in which this content is presented.

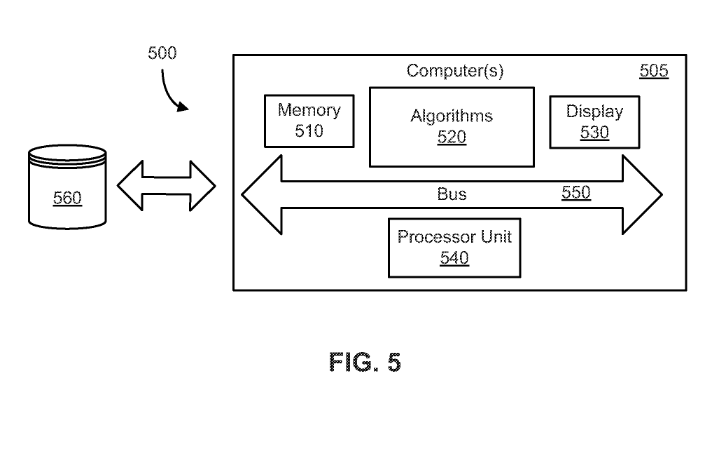

FIG. 5 is a block diagram of a computer system 500 in accordance with an example embodiment of the present invention. The computer system executes methods described herein, including one more of the blocks illustrated in FIGS. 2-4.

The computer system includes one or more databases or warehouses 560 coupled to one or more computers or servers 505.

By way of example, the computer 505 includes memory 510, algorithms 520, display 530, processing unit 540, and one or more buses 550. The processor unit includes a processor (such as a central processing unit, CPU, microprocessor, application-specific integrated circuit (ASIC), etc.) for controlling the overall operation of memory 510 (such as random access memory (RAM) for temporary data storage, read only memory (ROM) for permanent data storage, and firmware). The processing unit 540 communicates with memory 510 and algorithms 520 via one or more buses 550 and performs operations and tasks necessary for building user and website profiles for personalizing a website as explained herein. The memory 510, for example, stores applications, data, programs, algorithms (including software to implement or assist in implementing embodiments in accordance with the present invention) and other data.

In one example embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with example embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit the invention.

In the various embodiments in accordance with the present invention, embodiments are implemented as a method, system, and/or apparatus. As one example, example embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known physical and tangible media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method executed by a computer, comprising:
building a profile of a website from keywords appearing at the website;
building a profile of a user from a subset of the keywords that appear in documents accessed by the user; and
personalizing, based on the subset of the keywords, a web page to the profile of the user.

2) The method of claim 1 further comprising, supplementing a list of the keywords with other keywords extracted from websites other than the website having the keywords.

3) The method of claim 1 further comprising, sorting the subset of the keywords based on a user score of the keywords appearing in the documents and a website score of the keywords appearing at the website.

4) The method of claim 1 further comprising, personalizing the web page by using the subset of the keywords as queries to a search module of the web page to generate a ranked list of documents retrieved from the queries and organizing the ranked list into a body of content displayed on the web page.

5) The method of claim 1 further comprising:
submitting the keywords to a search engine that generates web pages;
extracting additional keywords from the web pages;
adding the additional keywords to the keywords to generate a list; and
building the profile of the user from keywords appearing in the list.

6) The method of claim 1, wherein the web page is automatically modified based on the profile of the user when the user navigates to the web page.

7) The method of claim 1, wherein the keywords appearing at the website are sorted by a probability P of a keyword k leading to a website w with the following:
P(w|k)=(P(k|w)·P(w))/P(k)∝(cₖ/cₖ)=S_{w}(k),
wherein Cₖ is an estimated number of k's occurrences in a network, and S_{w}(k) is a website score of k.

8) The method of claim 1 further comprising:
removing stopwords from the keywords;
dividing the keywords into unigrams and bigrams;
organizing the unigrams and the bigrams into a list of keywords; and
building the profile of the user from the list of keywords.

9) A tangible computer readable storage medium having instructions for causing a computer to execute a method, comprising:
generating a website profile from keywords appearing at the website;
generating, from the keywords appearing at the website, a user profile based on a frequency of the keywords appearing in documents other than the website and accessed by the user on a computer; and
personalizing a website based on the user profile.

10) The tangible computer readable storage medium of claim 9 having instructions for causing the computer to execute the method further comprising:
providing the keywords as a query to a search engine;
extracting additional keywords from search results of the search engine;
enhancing the keywords with the additional keywords; and
generating the user profile from both the keywords and the additional keywords.

11) The tangible computer readable storage medium of claim 9 wherein the website profile is generated by:
crawling the website to obtain the keywords;
cleaning the keywords to create a list of key phrases; and
sorting the list of key phrases by a probability of a key phrase leading to the website.

12) The tangible computer readable storage medium of claim 9 having instructions for causing the computer to execute the method further comprising, enhancing the keywords with other keywords appearing at other websites when a number of the keywords is not large enough to generate a description of the website.

13) The tangible computer readable storage medium of claim 9, wherein the user profile includes list of keywords that are of mutual interest to both the user and the website.

14) The tangible computer readable storage medium of claim 9 having instructions for causing the computer to execute the method further comprising, personalizing the website by displaying products and services customized to activities of the user obtained from information appearing in the documents accessed by the user on the computer

15) The tangible computer readable storage medium of claim 9 having instructions for causing the computer to execute the method further comprising, augmenting the website profile with keywords appearing at other websites when the keywords appearing at the website are not sufficient to describe products and services offered at the website.

16) A computer system, comprising:
a computer that executes an algorithm to:
build a model of a website from keywords appearing at the website;
build a model of a user from a subset of the keywords that appear in documents other than the website and accessed by the user; and
customize, based on the subset of the keywords, a web page being displayed to the user.

17) The computer system of claim 16, wherein the computer further executes the algorithm to customize the web page to display products and services interested to the user based on the model of the user.

18) The computer system of claim 16, wherein the computer further executes the algorithm to augment the model of the website with keywords appearing at other websites when the keywords appearing at the website are not sufficient to describe products and services offered at the website.

19) The computer system of claim 16, wherein the computer further executes the algorithm to scan the documents accessed by the user for the keywords appearing at the website.

20) The computer system of claim 16, wherein the computer further executes the algorithm to sort the subset of the keywords based on a user score of the keywords appearing in the documents and a website score of the keywords appearing at the website.
